(19) United States
(12) Patent Application Publication
(10) Pub. No.: US 2016/0136991 A1
(43) Pub. Date: May 19, 2016

(54) BOOKBINDING METHOD

(71) Applicant: Edwin C. Glickman, Basalt, CO (US)

(72) Inventor: Edwin C. Glickman, Basalt, CO (US)

(21) Appl. No.: 14/541,405

(22) Filed: Nov. 14, 2014

(51) Int. Cl. B42D 15/00

(52) U.S. Cl. CPC B42D 15/00

(57) ABSTRACT

A method is disclosed for making books, booklets and pamphlets (“bound publications”) with virtually any number of pages. In this method, the bound publications are configured to facilitate page turning for individuals with limited dexterity, such as older individuals and individuals with disabilities. In this method, the width of successive pages varies incrementally and progressively from the top sheet to the bottom sheet. The incremental widths between sheets can vary, for example, between 1/16 inch and ¼ inch. In order to enable the method to be used with bound publications of virtually unlimited page numbers, multiple sets of pages with incrementally varying widths, separated by spacers, for example, tab dividers, can be used to form a book. Each set of pages consists of a plurality of pages with successive pages having incrementally and progressively varying widths. Virtually any multiple of sets of pages can be used to form bound publications. As such, the method can be used for bound publications with a virtually unlimited number of pages. The sets of pages as well as the spacers are bound along a common edge, for example, by conventional binding methods.

### BACKGROUND OF THE INVENTION

1. Field of the Invention

The present invention relates to a method of binding books to facilitate page turning by the elderly and those with disabilities that make page turning of books difficult and cumbersome.

2. Description of the Prior Art

Various bookbinding systems are known in the art to facilitate page turning. Examples of such systems are disclosed in the following patent publications: Chinese Published Patent Application No. CN201366847; Japanese Published Patent Application Nos. JP2004034625; JP2005314101; JP2006231887; JP2009172990; Japanese Patent Nos. JP551561750; JP8267955; and JP3061884; US Patent Application Publication No.: US 2008/0191459 and U.S. Pat. Nos. 1,311,733 and 4,877,269; all hereby incorporated by reference.

These patent publications can be divided into two general categories as a function of the type of page processing used in the method. One category relates to a process that includes a cut along one edge of the paper. The other category relates to a folding process.

Both of these methods have drawbacks. In the one category that includes a cut along one edge there are two different methods disclosed in the art. In one method each successive sheet is incrementally larger or smaller than the adjacent sheet. An example of this method is disclosed in Chinese Patent Application Publication CN 2013366847. In this method, rectangular sheets of paper are bound along a top edge of each sheet along a short axis. The bottom edges of each sheet are cut so that successive sheets are incrementally larger or smaller than an adjacent sheet. If the increment between each sheet is ⅛th inch, then every eight sheets results in a difference in length the shortest sheet to the longest sheet is 1 inch. For every sixteen sheets the difference in length between the shortest sheet to the longest sheet is 2 inches. While the pages have uniform widths, such a system may be suitable for a pamphlet. It would not be suitable for books and pamphlets having more than a few pages because of the variance in the length.

US Patent Application Publication No. 2008/01901459 A1 discloses a book wherein an edge of each page opposite the binding is cut into a different shape. In this invention, each page has a variable width. Moreover, the edges of each page are cut in a way that requires ordering of successive pages. Such a method of binding a book is relatively complicated is not amenable to automatic machine processing.

Other methods of binding pages of a book in a way that facilitates page turning are disclosed in Japanese Patent Application Publication No. JP 2004034625 and U.S. Pat. No. 4,877,269. In these patent documents, portions of the edges of the pages opposite the book spine are cut out.

Referring first to Japanese Patent Application Publication No. JP 2004034625, this publication illustrates a method in which the edges of the pages of the book are cut so that a top portion of the pages are cut to form an inclined plane in one direction and the bottom portion of the pages are cut to form an inclined plane in an opposite direction.

U.S. Pat. No. 4,877,269 discloses another method for binding a book that facilitates page turning. In this method, notches are cut into the edges of the pages opposite the book spline. The notches are cut so that the width of notches on successive pages is incrementally smaller. The patent discloses multiple sets of the notches discussed above.

Although the methods discussed in the Japanese Patent Application Publication No. JP 2004034625 and U.S. Pat. No. 4,877,269 facilitate page turning, these methods are relatively complicated. Both of these methods require at least one cut along an edge of each page opposite the spline requiring non-uniform page sizes. In addition, the cuts require the pages to be assembled in a specific order.

Japanese Patent Application Publication No. JP 3061884 discloses another book binding method. In this method, the pages are the same size. In order to facilitate page turning, multiple notches are provided along the edges of the pages. In particular, incrementally spaced notches on successive pages are provided on the top and bottom portions of successive pages opposite the spline. In addition, incrementally spaced apart notches on successive pages are provided along a bottom edge of each page. These spaced apart notches are arranged to allow page turning by way of a single finger. This method has several drawbacks. First and most important, because of the incrementally spaced notches, this method is only useful on pamphlets and books with a limited number of pages. Secondly, the manufacturing process is relatively complicated because of the need for the pages to be in a specific order in order to place the pages in proper order.

Japanese Patent No. 55161750 and Japanese Patent Appl. Publications JP2005314101 and JP2009172990 relate to various folding techniques designed to vary the page width of successive pages in a book in order to facilitate page turning. Referring first to Japanese Patent No. 55161750, this patent discloses forming a pamphlet from a plurality of equal width sheets. Each sheet is folded at successive incremental distances from the page centerline. Each sheet forms two (2) pages. The first sheet forms the shortest page and the longest page based upon being folded a first incremental distance from the centerline of the page. The second page is folded a second incremental distance from the first fold creating a page having a width that is incrementally less than the longest page and incrementally wider than the shortest page. Japanese Patent Appl. Publications JP2005314101 and JP2009172990 are similar and rely on folding sheets to form pages of incrementally different widths. The problem with the technique disclosed in these publications is the same as described above; namely, it is not useful for books and pamphlets having more than a few pages.

Japanese Patent Application Publication No. JP2006231887 discloses a method for binding a book that facilitates page turning. In this method the size of successive sheets are alternated. For example, a standard size sheet is alternated with sheets that are smaller by 1 cm in both the horizontal and vertical directions. This technique is used for picture books. It is not amenable to text pages because of the differences of page sizes which would result in non-uniform margins on the standard sheets relative to the smaller sheets making reading of the text from page to page more difficult and uncomfortable.

Japanese Patent Application Publication No. JP 8267955 discloses a technique that utilizes sheets of different widths. Each sheet is folded at its respective centerline thus creating pages of different widths. The sheets are bound together at the centerlines of each of the sheets so that the pages with the widest width are on the outside. The balance of the sheets are disposed so that the pages with widths that are incrementally smaller are disposed so that the pages with the widest width are disposed on the on the bottom of the stack of sheets. Sheets with incrementally smaller widths are stacked on top and pages with smaller page widths are stacked so that the page widths of successive pages are incrementally smaller than the page width of the page below it. U.S. Pat. No. 7,338,084 discloses a similar technique. These techniques have the same problem as discussed above; namely that they can only be used for pamphlets and books with relatively few pages.

U.S. Pat. No. 1,311,733 discloses a “fan folded book.” This patent discloses a book with no spline. Instead the pages are all attached together from long edge to long edge in an accordion style. This technique requires all of the pages to be connected together. This technique would require pages to be printed and then bound together in accordion style. As such, this technique is relatively complicated to manufacture and may be unpopular with readers that are used to reading books with splines.

Thus, there is a need for a method for manufacturing a book that facilitates page turning that can be used with books with virtually any number of pages.

### SUMMARY OF THE INVENTION

A method is disclosed for making books, booklets and pamphlets (“bound publications”) with virtually any number of pages. In this method, the bound publications are configured to facilitate page turning for individuals with limited dexterity, such as older individuals and individuals with disabilities. In this method, the width of successive pages varies incrementally and progressively from the top sheet to the bottom sheet. The incremental widths between sheets can vary, for example, between 1/16 inch and ¼ inch. In order to enable the method to be used with bound publications of virtually unlimited page numbers, multiple sets of pages with incrementally varying widths, separated by spacers, for example , tab dividers, can be used to form a book. Each set of pages consists of a plurality of pages with successive pages having incrementally and progressively varying widths. Virtually any multiple of sets of pages can be used to form abound publication. As such, the method can be used for bound publications with a virtually unlimited number of pages. The sets of pages as well as the spacers are bound along a common edge, for example, by conventional binding methods.

### DESCRIPTION OF THE DRAWING

These and other advantages of the present invention will be readily understood with reference to the following specification and attached drawing wherein:

FIG. 1 is an isometric view of an exemplary embodiment of a bound publication illustrating multiple sets of pages with incrementally and progressively different widths, shown open with multiple dividers and several pages turned back, wherein the pages with the smallest width are on top and the pages with the largest width are on the bottom of the stack of pages.

FIG. 2 is an exploded isometric view of the bound publication illustrated in FIG. 1.

FIG. 3 is similar to FIG. 1 but illustrates an embodiment in which the pages with the largest widths are shown on top and the pages with the smallest widths are shown on the bottom of the stack of pages, shown with several of the top pages cut away.

FIG. 4 is block diagram illustrating the process for forming the exemplary embodiments illustrated in FIGS. 1 and 3.

### DETAILED DESCRIPTION

A method is disclosed for making books, booklets and pamphlets (“bound publications”) with virtually any number of pages. In this method, the bound publications are configured to facilitate page turning for individuals with limited dexterity, such as older individuals and individuals with disabilities. In this method, the width of successive pages varies incrementally and progressively from the top sheet to the bottom sheet. The incremental widths between sheets can vary, for example, between 1/16 inch and ¼ inch. In order to enable the method to be used with bound publications of virtually unlimited page numbers, multiple sets of pages with incrementally varying widths, separated by spacers, for example , tab dividers, can be used to form a book. Each set of pages consists of a plurality of pages with successive pages having incrementally and progressively varying widths. Virtually any multiple of sets of pages can be used to form bound publications. As such, the method can be used for bound publications with a virtually unlimited number of pages. The sets of pages as well as the spacers are bound along a common edge, for example, by conventional binding methods, such as hard cover binding, punch and bind, thermally activated binding, stitched or sewn binding, spiral binding or other conventional book binding methods.

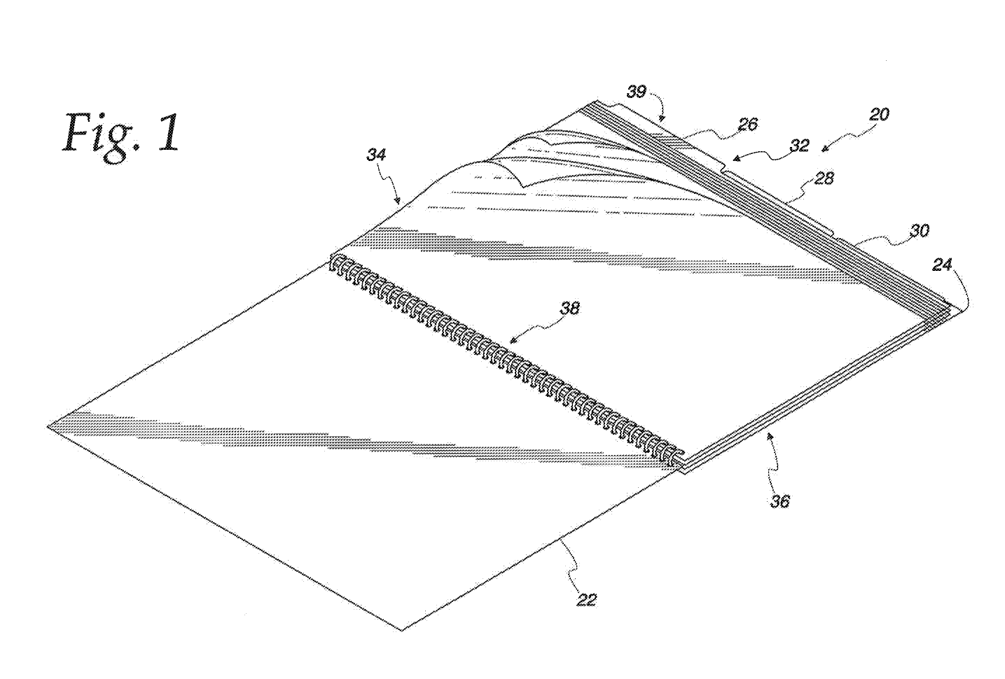

Referring first to FIG. 1, a first embodiment of a bound publication is illustrated made by the method is illustrated. The bound publication, generally identified with the reference numeral 20, includes top and bottom publication covers 22 and 24. One or both of these covers 22 and 24 may be hard covers or soft covers. One or both of these covers 22 and 24 may be made from materials used in conventional books. Alternatively, one or both of the covers 22 and 24 may be made from materials not used in conventional books, such as paper. One or both of these covers 22 and 24 may be made from materials with various light transmissive properties, for example, transparent materials, semi-transparent materials, opaque materials as well as materials that are not light transmissive, for example, various grades of paper stock.

A plurality of spacers 26, 28 and 30 are disposed between the covers 22 and 24. These spacers 26, 28 and 30 are used to separate sets of pages, as will be discussed in more detail below. The spacers 26, 28 and 30 are illustrated as exemplary tabbed dividers. As shown, the tabbed dividers 26, 28 and 30 include tabs which extend outwardly from the width of the page to facilitate turning of the dividers and the set of pages associated with each divider 26, 28 and 30.

The spacers 26, 28 and 30 can include extending tabs on any of the free edges of the publication. As used herein, free edges refer to edges other than the bound edges of the pages. As shown, referring to FIG. 1, the elongated side edge, generally identified with the reference numeral 32, is opposite the bound edge. Top and bottom edges are indicated by the reference numerals 34 and 36, respectively. The bound edge is indicated by the reference numeral 38. As shown in FIG. 1, the publication is bound along one of the elongated side edges 38. The publication can also be bound along the side edge 32 or the top or bottom edges 34 or 36, respectively. The spacers 26, 28 and 30 may be made of various different materials including paper, fiber board and the like. As mentioned above, the spacers 26, 28 and 30 include tabs, generally identified with the reference numeral 39, that extend outwardly from an edge of the pages, for example, the elongated side edge 32 of the paper opposite the binding.

As shown, these tabs 39 are located at different distances from the top of the side edge 32. These tabs 39 may be disposed so as those contiguous tabs at least partially overlap each other or so that there is no overlap between contiguous tabs 39. In general, depending on the location of the binding, the tabs 39 can be formed along an edge opposite the binding. As such, if the top edge 34 of the pages were bound, the tabs 39 may be formed along the bottom edge 36. In general, the pages may be bound along any of the edges and the tabs 39 may be disposed to extend outwardly from any edge other than the bound edge. Three (3) tabs 39 are illustrated. More or fewer tabs are contemplated.

The spacers 26, 28 and 30 may also be used without tabs 39. For example, the spacers 26, 28 and 30 can be formed by relatively thick material that provides a gap, for example 1/32 inch, between contiguous sets of pages. In this embodiment, the spacers 26, 28 and 30 are provided with a relatively smaller cross sectional area than the pages. Other embodiments of the spacers 26, 28 and 30 are contemplated which separate sets of pages and facilitate page turning.

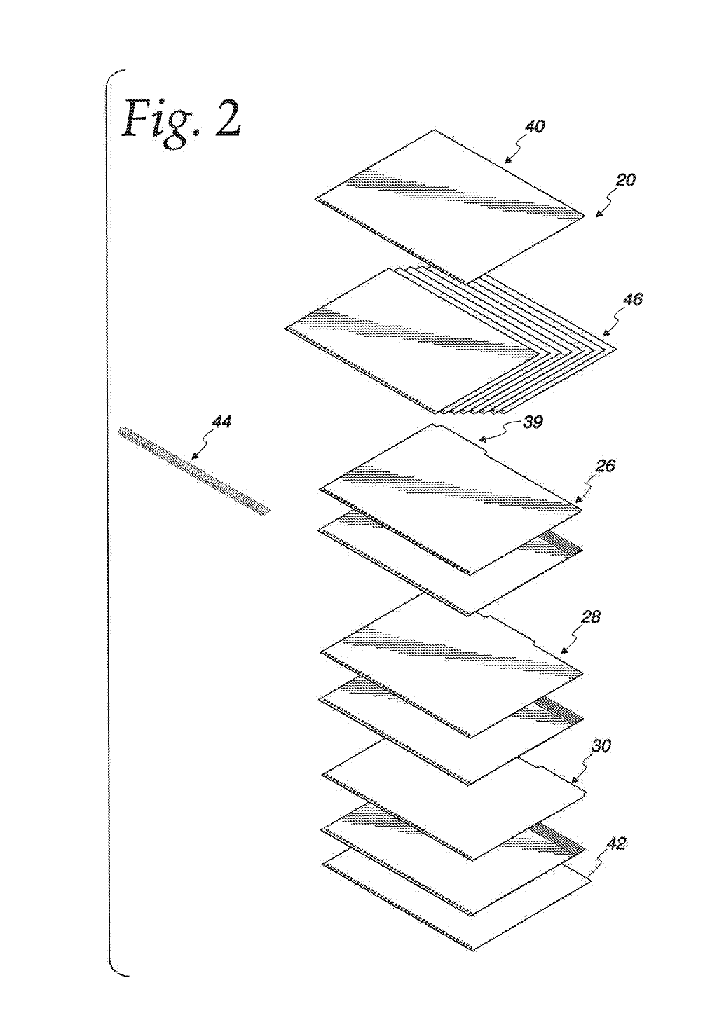

Turning to FIG. 2, an exploded isometric of a publication shown in FIG. 1 is illustrated. As shown, the publication 20 may include a front cover 40 and a back cover 42. As shown, the elongated side edge 38 of the sets of pages and the spacers 26, 28 and 30 are bound with a spiral binding 44. Other binding methods are contemplated.

In accordance with an important aspect of the invention, a set of pages, generally identified with the reference numeral 46 is disposed between the spacers 26, 28 and 30. More specifically, one set of pages 46 is disposed between the spacers 26 and 28. Another set of pages 46 is disposed between the spacers 28 and 30. In embodiments that include a front and back cover 40 and 42, as shown, a set of pages 46 may be disposed between the front cover 40 and another set of pages 46 may be disposed between the spacer 30 and the back cover 42.

Each set of pages 46 is configured such that the width (or length) of contiguous pages have an incrementally different width (or length) of the page before and the page after, as generally shown in FIG. 2. These increments may be, for example 1/16 or 1/32 inches, between successive pages and may be uniform or non-uniform for one set of pages 46. All of the sets of pages 46 in a publication may be uniform. Alternatively, different sets of pages 46 separated by different spacers 26, 28 and 30 may be provided with different increments.

The principles of the invention can be used to make publications of virtually any number of pages. For example, assuming increments between contiguous pages of 1/16 of inch, a set 46 of 16 pages would result in the difference between the widest (or longest) page and smallest (or shortest) page of 1 inch. A publication of 160 pages would require nine (9) spacers 26, 28 and 30 and a front 40 and back cover 42. By using the spacers 26, 28 and 30, turning pages in each set of pages 46 is greatly facilitated. Transitioning from one set of pages 46 to a contiguous set of pages 46 is also facilitated by the spacers 26, 28 and 30.

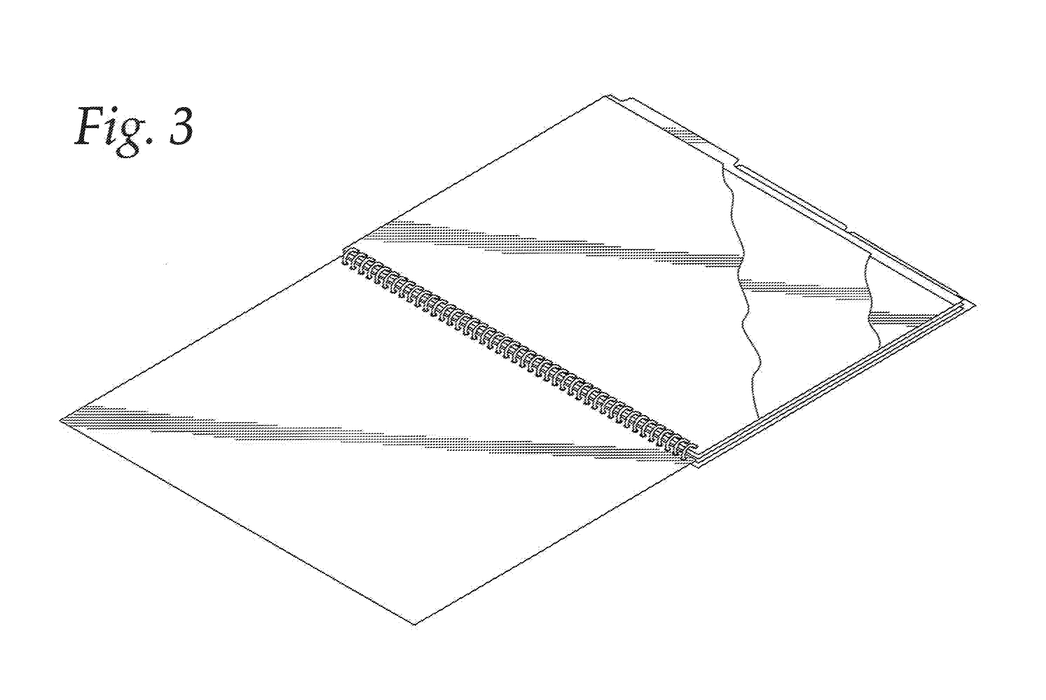

FIGS. 1 and 2 illustrate an embodiment in which the pages in a set of pages get progressively larger from the first page in the set to the last page in the set. FIG. 3 illustrates an embodiment that is similar to FIGS. 1 and 2 except that the pages are progressively smaller from the first page in the set to the last page in the set.

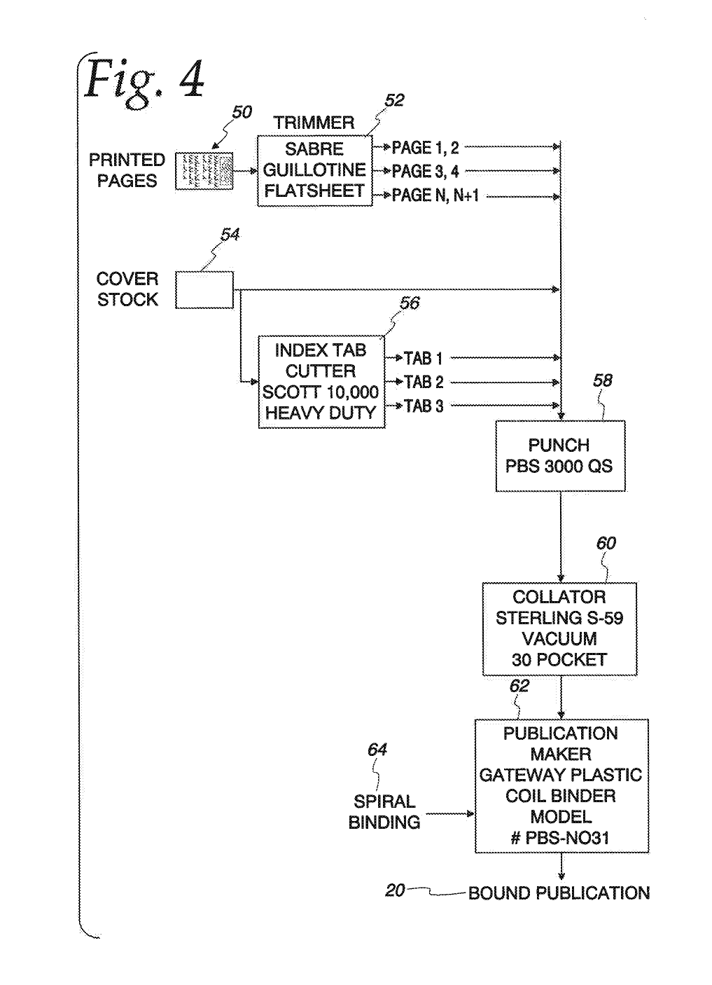

FIG. 4 is an exemplary process diagram for making a publication in accordance with the invention. Each set of printed pages 50 is fed into a trimmer 52 one at a time, for example, a Sabre Guillotine Flatsheet trimmer. This is done to provide the incremental dimensional difference between contiguous sheets, as discussed above. Cover stock 54 may be used for the front and back covers 40 and 42 as well as the spacers 26, 28 and 30. In this example, the spacers 26, 28 and 30 are fed into an index tab cutter 56. These spacers 26, 28 and 30 along with the front and back covers 40 and 42 are punched along the elongated edge 38 by a punch, for example, a PBS 3000 QS punch. The punched spacers 26, 28 and 30, front and back covers 40 and 42 along with multiple sets of punched printed pages 46 are collated by a collator 60 to form the publication 20. The unbound publication is fed into a publication maker 62, for example, a Gateway Plastic Coil Binder, Model #PBS-N031, along with spiral binding 64 to form the bound publication 20.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A method for making a publication with multiple pages for individuals with limited dexterity, the method comprising the steps of:
(a) assembling sets of printed pages in which contiguous pages have an incrementally dimensional difference relative to the sheet before and the sheet after;
(b) disposing spacers between contiguous sets of printed pages; and
(c) binding said spacers and said sets of pages to form a bound publication.

2. A bound publication comprising:
a plurality of sets of printed pages, wherein contiguous pages have an incrementally dimensional difference relative to the sheet before and the sheet after;
spacers disposed between contiguous sets of pages; and
a binding for binding said spacers and said contiguous sets of pages.
